(19) United States
(12) Patent Application Publication
(10) Pub. No.: US 2009/0184888 A1
(43) Pub. Date: Jul. 23, 2009

(54) Display control system and method thereof

(76) Inventors: Jyi-Yuan Chen, Tsao Tuen (TW); Chun-Huang Lee, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,998

(22) Filed: Jan. 18, 2008

(51) Int. Cl. G09G 5/00

(52) U.S. Cl. 345/2.3

(57) ABSTRACT

A display control system is provided. The display control system includes a first wireless apparatus and a second wireless apparatus. The first wireless apparatus processes a search function to obtain the character of the second wireless apparatus, and confirms whether the second wireless apparatus can connect to the first wireless apparatus according to the second apparatus character. When the second wireless apparatus is able to connect, the first wireless apparatus wirelessly connects to the second wireless apparatus, and outputs a first display signal to the second wireless apparatus. Then, the second wireless apparatus shows the first display signal on a display module for users to view the display contents of the first wireless apparatus on the display module of the second wireless apparatus.

### BACKGROUND OF THE INVENTION

1. Field of the Invention

The present invention relates to a control system and its method, and more particularly to a display control system that transmits control signals by a wireless method and the method thereof.

2. Description of Related Art

Since science and technology advance, various electronic apparatuses with different functions are developed to satisfy user requirements. In addition, wireless communication technology is developed rapidly, and a wireless transmission function is integrated into electronic apparatus, so that the electronic apparatuses can overcome the inconvenience of transmitting and receiving data via cables.

Various different functions are bundled into an electronic apparatus according to the requirements of different operations, but users may not be able to view a display screen of a remote electronic apparatus due to certain physical factors if some of these electronic apparatuses are used at different locations simultaneously.

For example, a driver may need to view a display screen of an electronic apparatus (such as a mobile phone, a PDA) for the operations while driving a car, but the personal electronic apparatus may not be located nearby. If the personal electronic apparatus is put at the backseat of the car, the driver has to move his/her body to get a hold of the electronic apparatus, and such movement will distract the driver's attention and cause a car accident easily.

Therefore, it is an urgent subject for manufacturers and designers to find a quick and convenient way for users to view a display screen of a remote electronic apparatus.

### SUMMARY OF THE INVENTION

In view of the foregoing shortcoming of the prior art, it is a primary objective of the present invention to overcome those shortcomings by providing a display control system and its method that allow a user to view a display screen of a remote wireless electronic apparatus, such that the user can view the display screen using another wireless electronic apparatus nearby.

To achieve the foregoing objective, the present invention provides a display control method, and the method focuses on a display control between a first wireless electronic apparatus and a second wireless electronic apparatus, and the method comprises: executing a search function by the first wireless electronic apparatus to obtain a second apparatus character that is returned by the second wireless electronic apparatus via a wireless transmission; determining the second apparatus character by the first wireless electronic apparatus to confirm whether or not the second wireless electronic apparatus is a connectable apparatus; connecting the first wireless electronic apparatus with the second wireless electronic apparatus, if the second wireless electronic apparatus is a connectable apparatus; outputting a first display signal to the second wireless electronic apparatus by the first wireless electronic apparatus via a wireless transmission, so that the second wireless electronic apparatus can use a second display module to display the first display signal.

To overcome the aforementioned technical problems, the present invention also provides a display control system, comprising: a first wireless electronic apparatus; and a second wireless electronic apparatus having a second display module and a second apparatus character. The first wireless electronic apparatus determines whether or not the second wireless electronic apparatus is a connectable apparatus by obtaining a second apparatus character of the second wireless electronic apparatus via a wireless search, and the first wireless electronic apparatus outputs a first display signal to the second wireless electronic apparatus via a wireless transmission if the first wireless electronic apparatus is connected with the second wireless electronic apparatus, such that the second wireless electronic apparatus can output and display the first display signal through the second display module.

With the foregoing solutions, the present invention allows users to view the display screen of the first wireless electronic apparatus directly through the second display module of the second wireless electronic apparatus.

To make it easier for our examiner to understand the expected objectives, technical measures and effects of the present invention, we use preferred embodiments together with the attached drawings for the detailed description of the invention, but it should be pointed out that the attached drawings are provided for reference and description only, but not for limiting the present invention.

### BRIEF DESCRIPTION OF THE DRAWINGS

FIG. 1 is a functional block diagram of a display control system in accordance with a preferred embodiment of the present invention;

FIG. 2 is a flow chart of a display control method in accordance with a preferred embodiment of the present invention;

FIG. 3 is a flow chart of communicating information between a first wireless electronic apparatus and a second wireless electronic apparatus in accordance with a preferred embodiment of the present invention; and

FIG. 4 is a functional block diagram of a display control system in accordance with another preferred embodiment of the present invention.

### DETAILED DESCRIPTION OF THE PREFERRED EMBODIMENTS

The present invention mainly allows two wireless electronic apparatuses to separately display a screen message provided by each other, and display the screen through their own display module, so that users can use a wireless electronic apparatuses nearby to view the display content provided for another wireless electronic apparatuses at a remote end.

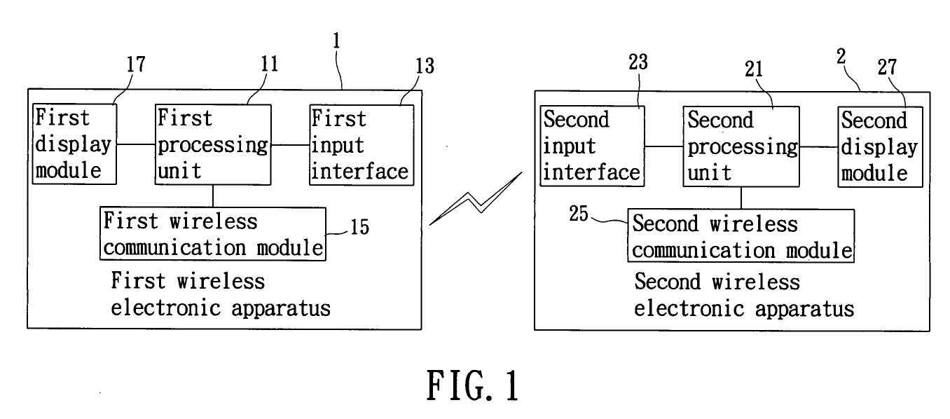

Referring to FIG. 1 for a functional block diagram of a display control system in accordance with a preferred embodiment of the present invention, the display control system comprises a first wireless electronic apparatus 1 and a second wireless electronic apparatus 2, wherein the first wireless electronic apparatus 1 and the second wireless electronic apparatus 2 separately display a display content provided by each other by executing a remote control function. In this embodiment, the remote control function is executed, so that users can view the display content provided by the first wireless electronic apparatus 1 through the second display module 27 of the second wireless electronic apparatus 2. Similarly, users can view the display content provided by the second wireless electronic apparatus 2 through the first display module 17 of the first wireless electronic apparatus 1.

A communication protocol mode is used for communications between the first wireless electronic apparatus 1 and the second wireless electronic apparatus 2, and both electronic apparatuses 1, 2 have a common control language for executing a processing procedure including the identification, online connection and receipt of remote input controls in the remote control function to achieve the communications between the two electronic apparatuses 1, 2.

The architecture and functions of the first wireless electronic apparatus 1 and the second wireless electronic apparatus 2 are described as follows. The first wireless electronic apparatus 1 comprises a first processing unit 11, a first input interface 13, a first wireless communication module 15 and a first display module 17, wherein the first processing unit 11 is coupled to the first input interface 13, the first wireless communication module 15 and the first display module 17 respectively. The second wireless electronic apparatus 2 comprises a second processing unit 21, a second input interface 23, a second wireless communication module 25 and a second display module 27, wherein the second processing unit 21 is coupled to the second input interface 23, the second wireless communication module 25 and the second display module 27 respectively. The first wireless electronic apparatus 1 and the second wireless electronic apparatus 2 can be electronic apparatuses of the same type or different types including a portable device such as a mobile phone, a personal digital assistant (PDA) and a portable navigation device (PND); or a Telematics system such as an automobile stereo, a digital mobile television, a navigator and an in-car computer.

The first processing unit 11 and the second processing unit 21 receive controls inputted by users through the first input interface 13 and the second input interface 23 respectively, and transmit and receive wireless signals with the outside or with each other through the first wireless communication module 15 and the second wireless communication module 25 respectively. The first processing unit 11 and the second processing unit 21 provide a main control mechanism for executing the functions and operations in the first wireless electronic apparatus 1 and the second wireless electronic apparatus 2, and the control mechanism can be operated together with hardware devices required for executing a microprocessor (not shown in the figure) and related functional modules. For example, the hardware device includes but not limited to a storage module, a navigation module or a stereo playing module, and can be different functional modules corresponding to different types of electronic devices, and the microprocessor executes a control procedure to achieve the functional operations provided by the devices, and the control procedure is generally implemented by program codes.

The control procedure executed by the first processing unit 11 includes the operation of a remote control function. In the execution of the remote control function, an identification data and related operation data are pre-stored in the first processing unit 11 for determining whether or not the second wireless electronic apparatus 2 can be connected and a remote control can be performed successfully. The identification data can be a first apparatus identification information for indicating the specification provided by the first wireless electronic apparatus 1. In this embodiment, the first apparatus identification information can be a hardware specification including the type, the quantity and the function of the input device in the first input interface 13 provided by the first input interface 13 and the first display module 17, and the display resolution and the display size of the first display module 17 provided for the second wireless electronic apparatus 2 to confirm whether or not the first input interface 13 of the first wireless electronic apparatus 1 is compatible to the second input interface 23, and let the display screen provided by the second wireless electronic apparatus 2 conform to the display specification of the first display module 17 of the first wireless electronic apparatus 1.

The first processing unit 11 further requires a related table to record the corresponding relation between the connectable apparatus and the input interface. For example, a selected connecting device is recorded in a first connection list and a corresponding relation between the second input interface 23 and the first input interface 13 is recorded in a first control conversion table. In the first control conversion table, a corresponding relation between different types of second input interfaces of the second wireless electronic apparatus 2 and the first input interface 13 of the first wireless electronic apparatus 1 is defined, so that the first wireless electronic apparatus 1 can use the first control conversion table to receive and identify a control signal inputted from the second input interface 23 of the second wireless electronic apparatus 2 to confirm the control information corresponding to the first input interface 13. For example, if both of the first input interface 13 and the second input interface 23 are press key modules, the first control conversion table at least records a corresponding relation between each press key in the press key module of the second input interface 23 and each press key in the press key module of the first input interface 13, and the executed functions.

Similarly, the operation of executing the remote control function at the second processing unit 21 is the same as that of the first processing unit 11, and the second processing unit 21 provides a second apparatus character, a second connection list and a second control conversion table, wherein the second apparatus character provides a hardware specification of the second input interface 23 and the second display module 27, such as the model, the quantity and the function of the input device in the second input interface 23 and the display resolution and the display size of the second display module 27 provided for the first wireless electronic apparatus 1 to confirm whether or not the second input interface 23 of the second wireless electronic apparatus 2 is compatible with the first input interface 13, and let the display screen provided by the first wireless electronic apparatus 1 fit the display specification of the second display module 27 of the second wireless electronic apparatus 2.

The second control conversion table defines a corresponding relation between the first input interface 13 of various models of the first wireless electronic apparatus 1 and the second input interface 23 of the second wireless electronic apparatus 2, so that the second wireless electronic apparatus 2 can receive and identify the control information inputted from the first input interface 13 of the first wireless electronic apparatus 1 through the second control conversion table to confirm the control of the control information corresponding to the second input interface 23.

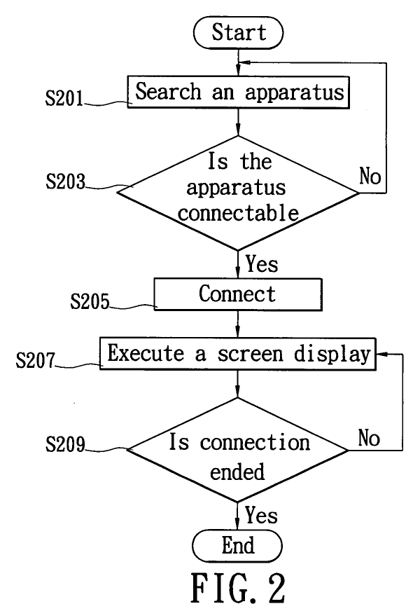

Referring to FIG. 2 for a flow chart of a display control method in accordance with a first preferred embodiment of the present invention, and FIG. 1 for the system architecture, the procedure of carrying out the display control method in accordance with this embodiment includes the steps of starting and executing the remote control function at the first wireless electronic apparatus 1 and the second wireless electronic apparatus 2, and requesting a connection with the second wireless electronic apparatus 2 by the first wireless electronic apparatus 1, and the embodiment is described as follows:

Firstly, the first wireless electronic apparatus 1 executes a wireless search function through the first wireless communication module 15 to search for an apparatus that supports the remote control function (S201). If the second wireless electronic apparatus 2 is searched, the first wireless electronic apparatus 1 will determine a second apparatus character in the second wireless electronic apparatus 2 to confirm whether or not the second wireless electronic apparatus 2 is a connectable apparatus (S203), and if the determination result is negative, then return to Step (S201) and continue searching for another connectable apparatus.

If the determination result of Step (S203) is affirmative, then the first wireless electronic apparatus 1 can be connected to the second wireless electronic apparatus 2 (S205), and after the connection is completed, the remote control function for displaying a screen is executed (S207), such that a first display signal provided by the first wireless electronic apparatus 1 can be displayed on the second display module 27 of the second wireless electronic apparatus 2, and then the connection between the first wireless electronic apparatus 1 and the second wireless electronic apparatus 2 is detected to determine whether or not it is ended (S209), and if the determination result is affirmative, then the execution of the remote control function is ended, or else the execution is continued by returning to Step (S207).

The invention is illustrated by the request for connecting the first wireless electronic apparatus 1 with the second wireless electronic apparatus 2 as shown in FIG. 2, and the first wireless electronic apparatus 1 provides a first display signal to the second wireless electronic apparatus 2 for the display, but the second wireless electronic apparatus 2 can also request a connection with the first wireless electronic apparatus 1 in actual implementation of the present invention, and the second wireless electronic apparatus 2 provides a second display signal to the first wireless electronic apparatus 1 for the display.

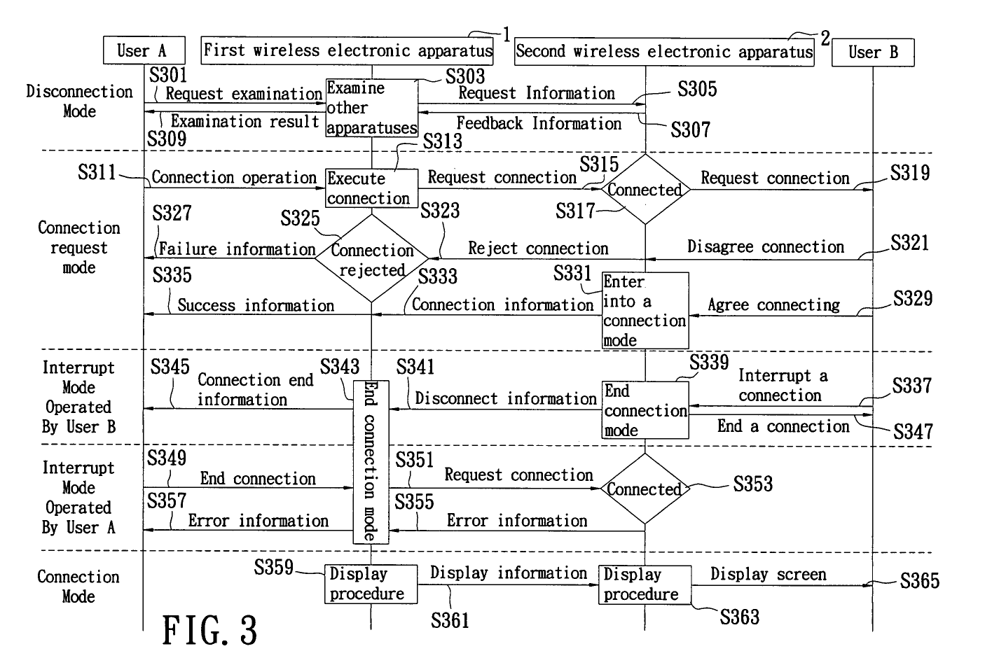

Referring to FIG. 3 for a more detailed description of the procedure as shown in FIG. 2, a flow chart illustrating the method of transmitting information between the first wireless electronic apparatus 1 and the second wireless electronic apparatus 2 in accordance with a preferred embodiment of the invention is provided. In FIG. 3, a user A requests a connection with the second wireless electronic apparatus 2 through first wireless electronic apparatus 1, and a user B views a first display signal provided by the first wireless electronic apparatus 1 through the second display module 27 of the second wireless electronic apparatus 2. A connection mode, a connection request mode, an interrupt mode operated by a user A, an interrupt mode operated by a user B, and a connected mode are described in FIG. 3, and the procedure as shown in FIG. 3 is described as follows:

The signal transmission between the first wireless electronic apparatus 1 and the second wireless electronic apparatus 2 is carried out through the first wireless communication module 15 and the second wireless communication module 25.

In a disconnected mode, the first wireless electronic apparatus 1 receives an examination request inputted by the user A through the first input interface 13 (S301) to examine whether or not there is any other apparatus provided for using the remote control function (S303) and output a request signal (S305) to any other electronic apparatus that supports the remote control function. After the second wireless electronic apparatus 2 has received the request signal, the second wireless electronic apparatus 2 outputs a feedback signal to the first wireless electronic apparatus 1 since the second wireless electronic apparatus 2 supports the remote control function (S307), and the content of the feedback signal is a second apparatus character. The first wireless electronic apparatus 1 determines whether or not the second wireless electronic apparatus 2 is an apparatus connectable to the first wireless electronic apparatus 1 according to the received second apparatus character for using the remote control function. The first wireless electronic apparatus 1 displays the determination result through the first display module 17 to inform the user A about the examination result of this time (S309).

The main purpose for the first wireless electronic apparatus 1 to determine the second apparatus character is to confirm whether or not the hardware specification of the second input interface 23 is compatible to the operation of the first input interface 13. Since the second apparatus character has recorded the related specification of the second input interface 23, therefore a corresponding relation between the second input interface 23 and the first input interface 13 is searched if the relation is defined for the current second wireless electronic apparatus 2 through the first control conversion table. If such relation exists, then the second wireless electronic apparatus 2 can be connected by the first wireless electronic apparatus 1 for use, or else the second wireless electronic apparatus 2 cannot be connected by the first wireless electronic apparatus 1 for use.

The connection request mode is described as follows. If the second wireless electronic apparatus 2 can be connected by the first wireless electronic apparatus 1 for use, then the second wireless electronic apparatus 2 is listed in the first connection list of the first wireless electronic apparatuses 1. By then, the first wireless electronic apparatus 1 can connect the second wireless electronic apparatus by clicking on the second wireless electronic apparatus in the first connection list that is received from the user A through the first input interface 13 (S311), so that the first wireless electronic apparatus 1 carries out the online connection function (S313) and outputs the connection request signal (S315) to the second wireless electronic apparatus 2. After the second wireless electronic apparatus 2 has received the connection request signal, the second wireless electronic apparatus 2 determines whether or not there is any other apparatus connected (S317), or if there is no content of information about a connection request outputted and displayed by the second display module 27 (S319) to remind the user B, and the second input interface 23 receives a consent for the connection inputted by the user B (S329). By then, the second wireless electronic apparatus 2 enters into a connection mode (S331) and outputs a connection signal (S333) to the first wireless electronic apparatus 1, and the first wireless electronic apparatus 1 outputs a connection success information to the user A through the first display module 17 (S335).

After the connection between the first wireless electronic apparatus 1 and the second wireless electronic apparatus 2 is completed, the first wireless electronic apparatus 1 outputs and displays the information of the display screen provided by the first wireless electronic apparatus 1 and displayed by the second wireless electronic apparatus 2 through the first display module 17, and the second wireless electronic apparatus 2 outputs and displays the display content corresponding to the information of the display screen provided by the first wireless electronic apparatus 1 through the second display module 27.

In the connection request mode, if the second wireless electronic apparatus 2 has received the connection request signal and there is another apparatus connected online, or the second wireless electronic apparatus 2 has received a rejection for the connection received by the user B through the second input interface 23 (S321), even though no other apparatus is connected, then the second wireless electronic apparatus 2 will output a reject signal (S323) to the first wireless electronic apparatus 1, and the first wireless electronic apparatus 1 determines whether or not the connection is rejected (S325). After the reject signal outputted by the second wireless electronic apparatus 2 is received, the first wireless electronic apparatus 1 outputs a connection failure signal to inform the user A through the first display module 17 (S327).

In an interrupt mode operated by the user B, the second wireless electronic apparatus 2 receives a disconnection request inputted by the user B through the second input interface 23 (S337), so that the second wireless electronic apparatus 2 ends the connection mode (S339), and the second wireless electronic apparatus 2 outputs a connection end signal to inform the user B through the second display module 27 (S347) and outputs a disconnection signal (S341) to the first wireless electronic apparatus 1, such that the first wireless electronic apparatus 1 ends the connection mode (S343), and the first wireless electronic apparatus 1 outputs the connection end signal to inform the user A through the first display module 17 (S345).

In the interrupt mode operated by the user A, the first wireless electronic apparatus 1 receives an end connection request inputted by the user A (S349) through the first input interface 13 to end the connection mode (S343) and then output the signal for requesting to end the connection (S351) to the second wireless electronic apparatus 2, and the second wireless electronic apparatus 2 determines whether or not it is in the connection mode (S353) after the signal is received. If the determination result is affirmative, then the second wireless electronic apparatus 2 will end the connection mode (S339) and output a disconnection signal (S341) to the first wireless electronic apparatus 1; and if the determination result is negative, then the second wireless electronic apparatus 2 will output an error signal (S355) to the first wireless electronic apparatus 1, such that the first wireless electronic apparatus 1 outputs the error signal to inform the user A through the first display module 17.

In a connected mode, the first wireless electronic apparatus 1 executes a display procedure of image processing (S359) to output a first display signal (S361) to the second wireless electronic apparatus 2 via a wireless transmission, and the second wireless electronic apparatus 2 receives the first display signal via a wireless transmission to execute a display procedure (S363), and the first display signal is outputted and displayed at the second display module 27 for the user B to view the display screen provided by the first wireless electronic apparatus 1 through the second display module 27 (S365).

Before the first wireless electronic apparatus 1 is connected online, the first wireless electronic apparatus 1 has obtained the second apparatus character from the second wireless electronic apparatus 2 through an inquiry and further learns the display resolution and the display size of the second display module 27 from the second apparatus character. Before the first wireless electronic apparatus 1 outputs the first display signal to the second wireless electronic apparatus 2, the first wireless electronic apparatus 1 executes an image processing for the first display signal according to the display resolution and the display size of the second display module 27, such that the display of the first display signal can fit the display specification of the second display module 27.

The image processing executed by the first wireless electronic apparatus 1 can be classified into the following types. In the first type, if the display size of the second display module 27 is greater than the display size of the first display module 17, then the first wireless electronic apparatus 1 executes an image zoom-in processing for the first display signal to zoom in a screen corresponding to the first display signal to fit the display size of the second display module 27. In the meantime, the resolution of the first display signal is adjusted to be compatible to the resolution adopted by the second display module 27. In the second type, if the display size of the second display module 27 is smaller than the display size of the first display module 17, then the first wireless electronic apparatus 1 will execute the zoom-out processing for the first display signal, such that the zoom-out screen corresponding to the first display signal can fit the display size of the second display module 27. In the meantime, the resolution of the first display signal is compatible to the resolution adopted by the second display module 27. In the third type, if the display size of the second display module 27 is equal to the display size of the first display module 17, then the first wireless electronic apparatus 1 will execute a zoom-out or zoom-in processing for the first display signal, and the resolution of the first display signal is adjusted to be compatible to the resolution adopted by the second display module 27.

The foregoing first display signal is a screen data expressed by the first display module 17, and the first wireless electronic apparatus 1 at the connected mode can continue outputting the first display signal to the second wireless electronic apparatus 2, or if the display content of the first display signal varies, the display content will be outputted to the second wireless electronic apparatus 2.

In addition, the second wireless electronic apparatus 2 receives a control event inputted by the user B through the second input interface 23 and outputs a decoded input operating information to the first wireless electronic apparatus 1 and the first wireless electronic apparatus 1 according to the input operating information from searches for a corresponding relation between the second input interface 23 and the first input interface 13 in the first control conversion table, and further learns the input operating information corresponding to the execution function of the first input interface 13. The first wireless electronic apparatus 1 inputs and processes an operation control event inputted by the second wireless electronic apparatus 2 according to the searched corresponding relation. Now, the display screen content of the first display module 17 may vary according to such operation event. In other words, the user B can control the function of the first wireless electronic apparatus 1 at a remote end through the second wireless electronic apparatus 2, and view the screen data displayed by the first display module 17 and controlled by the first wireless electronic apparatus 1 through the second display module 27.

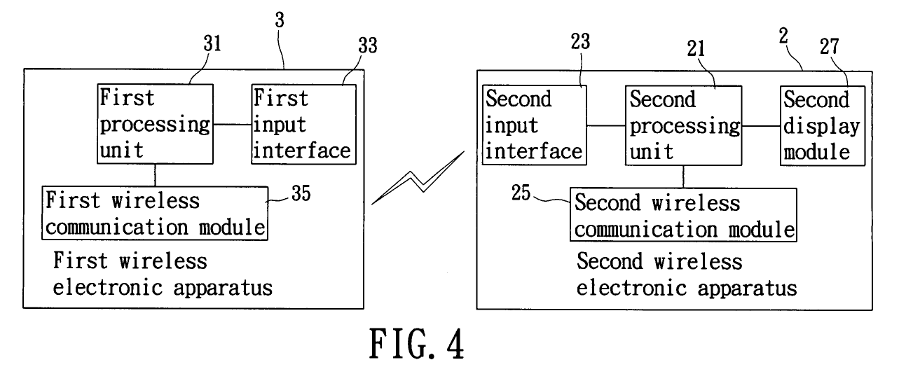

Referring to FIG. 4 for a functional block diagram of a display control system in accordance with a preferred embodiment of the present invention, another type of the first wireless electronic apparatus 3 is provided, and this first wireless electronic apparatus 3 does not come with the first display module 17, but comprises a first processing unit 31, a first input interface 33 and a first wireless communication module 35. Similarly, the first wireless electronic apparatus 3 can output the first display signal to the second wireless electronic apparatus 2, and the display screen data of the first display signal can be a predetermined display screen that is pre-stored in a display database (not shown in figure) in the first processing unit 31. With the method as disclosed in FIG. 4, the present invention also can use an electronic apparatus without a display module to output a display screen to another electronic apparatus at a remote end having a display module to display the display screen.

In a practical application of the embodiment, the first wireless electronic apparatus 1 can be a mobile phone, and the second wireless electronic apparatus 2 can be an automobile computer, and thus the implementation of this embodiment allows drivers to display a screen message of a mobile phone through the screen of the computer, and thus drivers can view the screen of the automobile computer without affecting the driving safety to conveniently control the display content of the mobile phone, and the content of the display screen of the automobile computer can be maintained the same as the display content of the mobile phone, and thus drivers do not have to get familiar with another new way of editing the display content.

The first input interface 13 and the second input interface 23 of the foregoing embodiment can be an input interface of different types such as a remote control module, a press key module, and a touch control module.

From the description of the foregoing preferred embodiment, the first wireless electronic apparatus 1 and the second wireless electronic apparatus 2 can show the display content of each other through their own first display module 17 and second display module 27, and the control with each other during the execution process is achieved by a wireless method, so that users can view the display screen of another wireless electronic apparatus from the display screen of a wireless electronic apparatus nearby, and the display content can be the same as the original display content, and thus users do not need to learn another new screen interface.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A display control method, applied to a display control between a first wireless electronic apparatus and a second wireless electronic apparatus, and the method comprising the steps of:
executing a search function by the first wireless electronic apparatus to obtain a second apparatus character returned from the second wireless electronic apparatus via a wireless transmission;
determining the second apparatus character by the first wireless electronic apparatus to confirm whether or not the second wireless electronic apparatus is a connectable apparatus;
connecting the first wireless electronic apparatus with the second wireless electronic apparatus, if the second wireless electronic apparatus is a connectable apparatus;
outputting a first display signal by the first wireless electronic apparatus to the second wireless electronic apparatus via a wireless transmission; and
a second display module of the second wireless electronic apparatus outputting and displaying a screen of the first display signal.

2. The display control method of claim 1, wherein the second apparatus character provides a hardware specification of a second input interface of the second wireless electronic apparatus.

3. The display control method of claim 2, wherein the first wireless electronic apparatus will confirm that the second wireless electronic apparatus is connectable if the first control conversion table contains the correspondence relationship of the first and the second input interfaces according to the second apparatus identification message.

4. The display control method of claim 3, wherein the second apparatus character further provides a display resolution and a display size of the second display module.

5. The display control method of claim 4, wherein the first display signal outputted by the first wireless electronic apparatus is a screen contents displayed by a first display module of the first wireless electronic apparatus.

6. The display control method of claim 5, wherein the first display signal undergoes image processing by the first wireless electronic apparatus before the first display signal is outputted to the second wireless electronic apparatus via a wireless transmission, such that the display content of the first display signal can conform to the display resolution and the display size of the second display module.

7. The display control method of claim 6, wherein the image processing is a zoom-in processing or a zoom-out processing.

8. The display control method of claim 4, wherein the first display signal outputted by the first wireless electronic apparatus is a predetermined display screen outputted by the first wireless electronic apparatus.

9. The display control method of claim 8, wherein the first display signal undergoes image processing by the first wireless electronic apparatus before the first display signal is outputted to the second wireless electronic apparatus via a wireless transmission, such that the display content of the first display signal can conform to the display resolution and the display size of the second display module

10. The display control method of claim 9, wherein the image processing is a zoom-in processing or a zoom-out processing.

11. The display control method of claim 1, further comprising the step of:
displaying the first wireless electronic apparatus to determine the second apparatus character to confirm a result whether or not the second wireless electronic apparatus is a connectable apparatus.

12. The display control method of claim 1, further comprising the step of:
adding the second wireless electronic apparatus into a first connection list of the first wireless electronic apparatus, if the second wireless electronic apparatus is a connectable apparatus.

13. The display control method of claim 1, further comprising the step of:
the first wireless electronic apparatus displaying a hint message of displaying a screen of the first wireless electronic apparatus by the second wireless electronic apparatus, if the first wireless electronic apparatus and the second wireless electronic apparatus are connected.

14. The display control method of claim 1, further comprising the step of:
the second wireless electronic apparatus displaying a hint message that is displayable on a screen of the first wireless electronic apparatus, if the first wireless electronic apparatus and the second wireless electronic apparatus are connected.

15. The display control method of claim 1, wherein before the first wireless electronic apparatus executes the search function, the method further comprising the step of:
the first wireless electronic apparatus and the second wireless electronic apparatus enabling a remote control function separately.

16. A display control system, comprising:
a first wireless electronic apparatus; and
a second wireless electronic apparatus, including a second display module and a second apparatus character;
wherein the first wireless electronic apparatus is provided for searching the second wireless electronic apparatus via a wireless transmission to obtain the second apparatus character of the second wireless electronic apparatus, and determine the second apparatus character to confirm whether or not the second wireless electronic apparatus is a connectable apparatus;
and if the second wireless electronic apparatus is a connectable apparatus, the first wireless electronic apparatus and the second wireless electronic apparatus are connected, and the first wireless electronic apparatus outputs a first display signal to the second wireless electronic apparatus via a wireless transmission, such that the second wireless electronic apparatus can output and display the first display signal through the second display module.

17. The display control system of claim 16, wherein the second apparatus character provides a hardware specification of a second input interface of the second wireless electronic apparatus.

18. The display control system of claim 17, wherein the first wireless electronic apparatus will confirm that the second wireless electronic apparatus is connectable if the first control conversion table contains the correspondence relationship of the first and the second input interfaces according to the second apparatus identification message.

19. The display control system of claim 17, wherein the second apparatus character further provides a display resolution and a display size of the second display module.

20. The display control system of claim 19 wherein the first display signal outputted by the first wireless electronic apparatus is a screen displayed by a first display module of the first wireless electronic apparatus.

21. The display control system of claim 20, wherein the first display signal undergoes image processing of the first wireless electronic apparatus before the first display signal is outputted to the second wireless electronic apparatus via a wireless transmission, such that the display content of the first display signal can conform to the display resolution and the display size of the second display module.

22. The display control system of claim 21, wherein the image processing is a zoom-in processing or a zoom-out processing.

23. The display control system of claim 19, wherein the first display signal outputted by the first wireless electronic apparatus is a predetermined display screen of the first wireless electronic apparatus.

24. The display control system of claim 23, wherein the first display signal undergoes image processing by the first wireless electronic apparatus before the first display signal is outputted to the second wireless electronic apparatus via a wireless transmission, such that the display content of the first display signal can conform to the display resolution and the display size of the second display module.

25. The display control system of claim 24, wherein the image processing is a zoom-in processing or a zoom-out processing.
